(19) United States
(12) Patent Application Publication
(10) Pub. No.: US 2003/0041704 A1
(43) Pub. Date: Mar. 6, 2003

(54) Socket-drive anvil element for an impact wrench

(76) Inventor: Donald Van Pelt, Queen Creek, AZ (US)

Correspondence Address: Jordan M. Meschkow, MESCHKOW & GRESHAM, P.L.C., Suite 409, 5727 N. Seventh Street, Phoenix, AZ, 85014, US

(21) Appl. No.: 09/947,453

(22) Filed: Sep. 5, 2001

(51) Int. Cl. B25B 21/00

(52) U.S. Cl. 81/466

(57) ABSTRACT

A socket-drive anvil element (22, 94) includes a base (44, 96) configured for alignment with a rotational axis (47) of a rotary motor (38) of an impact wrench (20, 92). The socket-drive element (22, 94) further includes a plug element (50) configured for receipt of a wrench socket (24). The plug element (50) includes side faces (48) coupled to and extending from the base (44, 96). A top face (54) is coupled to a distal edge (56) of the side faces (48). A first and second side face (58, 60) of the side faces (48) and the top face (54) include a continuous groove (62) formed therein. A spring wire element (68) is secured in the groove (62) and is configured to provide resistance to the removal of the wrench socket (24) from the plug element (50).

### TECHNICAL FIELD OF THE INVENTION

The present invention relates to the field of impact wrenches. More specifically, the present invention relates to improvements in the retention of a wrench socket on an anvil of an impact wrench

### BACKGROUND OF THE INVENTION

An impact wrench is a wrench operated electrically or pneumatically to provide a rapid succession of sudden torque. An air impact wrench typically includes a rotary motor operated by compressed air to impart a rotary motion to a socket drive member, known as an anvil, located on the front end of the motor shaft. Differently sized wrench sockets are selectively attached to the anvil. Impact wrenches are used for performing such activities as tightening nuts onto bolts in, for example, the automotive industry, assembly facilities, and other applications requiring heavy nut and bolt driving.

The drive end of the anvil typically includes a retainer mechanism for retaining the wrench socket on the anvil. Typical retainer mechanisms include detent mechanisms, such as plungers, spring-operated balls, and so forth, that hold the wrench socket onto the anvil until an external force is applied to the wrench socket. In a detent mechanism, the plunger or ball retracts into the anvil as the wrench socket is being installed on the anvil. When the socket is in a final position, the plunger or ball pops out of the anvil to seat in a corresponding hole in the socket. Another retainer mechanism includes the use of an O-ring surrounding part of the anvil. The O-ring provides friction to retain the wrench socket onto the anvil and provides an air seal between the anvil and the wrench socket.

A problem that arises with high frequency use of an impact wrench in, for example, a commercial application is that the retainer mechanism wears out within a matter of months due to the repeated installation and removal of the wrench socket. For example, the plunger, ball, or O-ring wears down, or the spring mechanism associated with the plunger or ball loses its resiliency. This undesirable wear of the retainer mechanism causes the wrench socket to fall off of the anvil, resulting in work slowdown, lost sockets, damage to the work item, and possible injury to the user, and leads to the replacement of the expensive drive end of the anvil or the entire anvil.

Another prior art retainer mechanism is a pin and through-hole mechanism, used alone or in combination with the O-ring. In a pin and through-hole mechanism, a hole is bored through the drive end of the anvil. As such, the wrench socket is installed on the anvil, and a pin is passed through corresponding holes in the wrench socket and the hole in the anvil to retain the wrench socket onto the anvil. The pin and through-hole mechanism circumvents the problems of anvil wear in the detent and O-ring mechanisms. However, problems associated with the pin and through-hole mechanism include slower installation and removal of the wrench sockets, loss of the retaining pin, and increased costs associated with specialized wrench sockets having the corresponding holes.

### SUMMARY OF THE INVENTION

Accordingly, it is an advantage of the present invention that a socket-drive anvil element is provided.

It is another advantage of the present invention that a socket-drive anvil element is provided that effectively retains a socket wrench in a high usage environment.

It is yet another advantage of the present invention that a socket-drive anvil element is provided that allows for the ready installation and removal of a wrench socket.

Yet another advantage of the present invention is that a socket-drive anvil element is provided that is readily implemented on pre-existing impact wrenches and on new impact wrenches.

The above and other advantages of the present invention are carried out in one form by a socket-drive anvil element for an impact wrench, the impact wrench having a motor for providing a rotary drive force to a wrench socket. The anvil element includes a base configured for alignment with a rotational axis of the motor and a plug element configured for receipt of the wrench socket. The plug element includes side faces and a top face. The side faces are coupled to and extend from the base, and the top face is coupled to a distal edge of the side faces. A first side face and a second side face of the side faces and the top face have a continuous groove formed therein. A spring wire element is secured in the groove and is configured to provide resistance to removal of the wrench socket.

The above and other advantages of the present invention are carried out in another form by a socket-drive anvil element adapter for an impact wrench, the impact wrench having a motor for providing a rotary drive force to a wrench socket, and the impact wrench including a pre-existing anvil. The anvil element adapter includes a base having a socket portion configured for interconnection the pre-existing anvil and axially aligned with a rotational axis of the motor. A plug element is configured for receipt of the wrench socket, the plug element including side faces and a top face. The side faces are coupled to and extend from the base, and the top face is coupled to a distal edge of the side faces. A first side face and a second side face of the side faces and the top face have a continuous groove formed therein. A spring wire element is secured in the groove and is configured to provide resistance to removal of the wrench socket. The spring wire element is a continuous unit shaped to include a first leg, an intermediate portion, and a second leg. The first leg is positioned in the groove on the first side face. The intermediate portion is positioned in the groove on the top face, and the second leg is positioned in the groove on the second side face.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows an exploded side view of an impact wrench, a socket-drive anvil element, and a wrench socket;

FIG. 2 shows an exploded perspective view of the socket-drive anvil element of FIG. 1;

FIG. 3 shows a side view of the socket-drive anvil element of FIG. 1;

FIG. 4 shows a profile view of a second spring wire element of the socket-drive anvil element in accordance with an alternative embodiment of the present invention;

FIG. 5 shows a profile view of a third spring wire element of the socket-drive anvil element in accordance with another alternative embodiment of the present invention;

FIG. 6 shows a side view of an impact wrench having a socket-drive anvil element in accordance with an alternative embodiment of the present invention; and

FIG. 7 shows a perspective view of the socket-drive anvil element of FIG. 6.

### DETAILED DESCRIPTION OF THE PREFERRED EMBODIMENTS

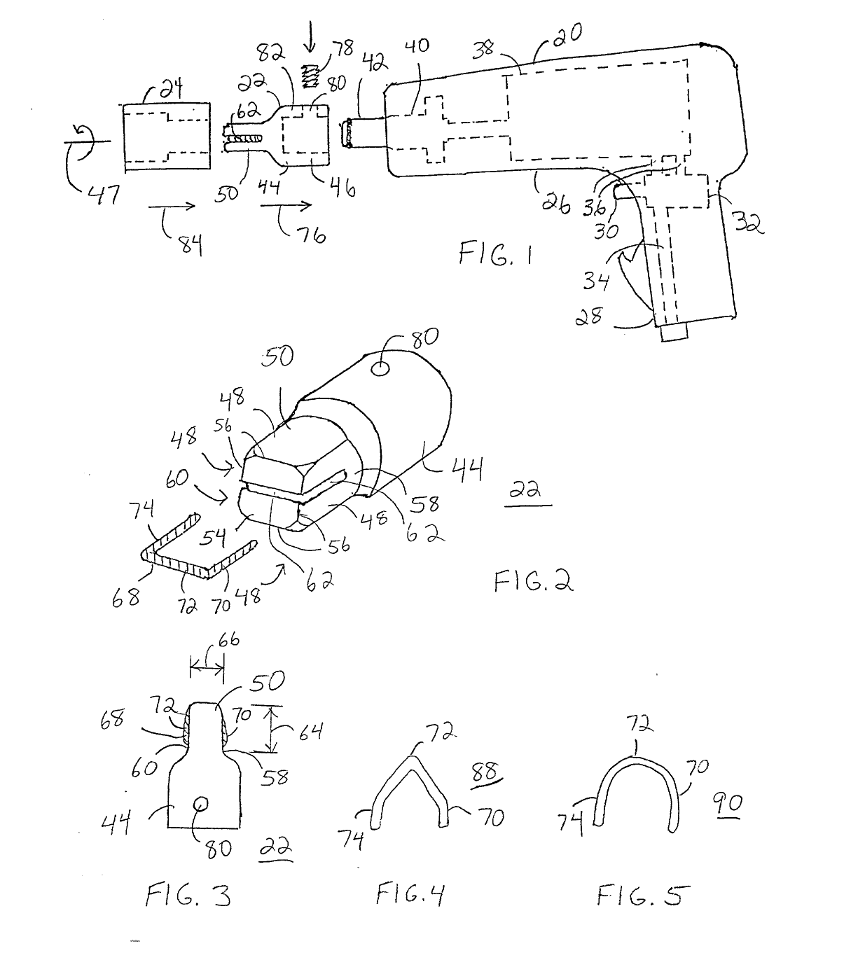

FIG. 1 shows an exploded side view of an impact wrench 20, a socket-drive anvil element 22, and a wrench socket 24. Impact wrench 20 is a commercially available wrench operated by compressed air. Wrench 20 includes a housing 26. Housing 26 includes a handle 28 that supports a finger-operated trigger 30 connected to a valve 32 for controlling a flow of compressed air through passages 34 and 36 to a rotary motor 38. Motor 38 includes a hollow drive shaft that is attached to a rotary anvil 40. A drive end of anvil 40 is configured as a square cross-sectioned plug 42.

Plug 42 is adapted to fit into wrench socket 24. However, as discussed previously, the drive end of anvil 40, i.e., plug 42, suffers from excessive wear of retainer mechanism elements in a high usage environment. In order to prevent excessive wear of plug 42 of anvil 40, or to mitigate the problems resulting from excessive wear that has previously occurred to plug 42, socket-drive anvil element 22 is interposed between plug 42 and wrench socket 24. In such a manner, socket-drive anvil element 22 is an adapter configured for receipt of wrench socket 24 tht provides an economical solution for continued use of impact wrench 20 without undergoing an expensive replacement of anvil 40. Thus, anvil 40 is referred to as pre-existing anvil 40 hereinafter, and socket-drive anvil element 22 is referred to as anvil element adapter 22 hereinafter.

Impact wrench 20 is described as being an air impact wrench, or pneumatic tool, operated using compressed air. However, it should be understood that the present invention may alternatively be utilized on an electrically operated impact wrench, or on a hand operated wrench, such as a ratchet wrench. In an exemplary embodiment, plug 42 of impact wrench 20 is a half inch drive end. Alternatively, anvil element adapter 22 may be configured to fit on other impact wrenches having different sized drive ends, such as a one quarter or a three eighths inch drive ends.

Referring to FIGS. 1-2, FIG. 2 shows an exploded perspective view of anvil element adapter 22. Anvil element adapter 22 includes a base 44 having a socket portion 46 configured for interconnection with plug 42 of pre-existing anvil 40 and for alignment with a rotational axis 47 of rotary motor 38. Four side faces 48 of a plug element 50 of adapter 22 are coupled to and extend from base 44. Plug element 50 further includes a top face 54 coupled to a distal edge 56 of side faces 48. A first side face 58 and a second side face 60 of side faces 48 are positioned on opposite sides of plug element 50. First and second side faces 58 and 60, respectively, and top face 54 include a continuous groove 62 formed therein.

Referring to FIG. 3 in connection with FIGS. 1-2, FIG. 3 shows a side view of anvil element adapter 22. In a preferred embodiment, groove 62 is approximately 0.08″ deep and 0.08″ wide. In addition, groove 62 extends substantially along a length 64 of first and second side faces 58 and 60, respectively, and across a width 66 of top face 54.

A spring wire element 68 is secured in groove 62 and is configured to provide resistance to removal of wrench socket 24. Spring wire element-68 is-a continuous unit shaped to include a first leg 70, an intermediate portion 72, and a second leg 74. First leg 70 is positioned in groove 62 on first side face 58, intermediate portion 72 is positioned in groove 62 on top face 54, and second leg 74 is positioned in groove 62 on second side face 60. Intermediate portion 72 is secured in groove 62 in top face 54 by spot welding or by crimping the edges of groove 62.

In a preferred embodiment, spring wire element 68 is formed from 0.0625″ diameter piano spring wire, a carbon-steel wire that is cold drawn to a very high tensile strength. Once the piano spring wire is bent to the U-shape of spring wire element 68 having first leg 70, intermediate portion 72, and second leg 74, the piano spring wire is heat-treated, or tempered. Heat-treatment of spring wire element 68 results in a gain of hardness and resiliency of spring wire element 68 over wire that had not been heat-treated.

As shown in FIG. 3, when spring wire element 68 is secured in groove 62, first and second legs 70 and 74, respectively, extend slightly from groove 62. The extension of first and second legs 70 and 74 imposes an outward force onto wrench socket 24 thereby providing friction between plug element 50 of anvil element adapter 22 and wrench socket 24. This friction serves to retain socket 24 on plug element 50. In addition, first and second legs 70 and 74 retract into groove 62 in response to an external forced imposed on wrench socket 24 to readily release wrench socket 24 from plug element 50, or alternatively, to readily install wrench socket 24 onto plug element 50.

Referring particularly to FIG. 1, in operation, anvil element adapter 22 is slid onto plug 42 of pre-existing anvil 40, as represented by an arrow 76. Anvil element adapter 22 further includes a set screw 78 and socket portion 46 includes a hole 80 extending through a side wall 82 of socket portion 46. Once anvil element adapter 22 is slid onto plug 42, set screw 78 is threaded through hole 80 until set screw 78 abuts plug 42 of pre-existing anvil 40. Thus, set screw 78 retains anvil element adapter 22 onto pre-existing anvil 40 regardless of the damage or wear imposed on the original retainer mechanism on pre-existing anvil 40 due to high use.

Once anvil element adapter 22 is secured in place on plug 42, wrench socket 44 is secured to plug element 50 of anvil element adapter 22, as represented by an arrow 84, with first and second legs 70 and 74 of spring wire element 68 applying outward pressure on socket 24 to retain socket 24 onto plug element 50. Base 44 of anvil element adapter 22, and consequently plug element 50 and socket 24, is aligned with rotational axis 47 of rotary motor 38. Accordingly, when wrench socket 24 is secured onto plug element 50, motor 38 provides a rotary drive force to socket 24.

Referring to FIGS. 4-5, FIG. 4 shows a profile view of a second spring wire element 88 of anvil element adapter 22 (FIG. 1) in accordance with an alternative embodiment of the present invention. FIG. 5 shows a profile view of a third spring wire element 90 of anvil element adapter 22 in accordance with another alternative embodiment of the present invention. Spring wire element 68 (FIG. 2) is desirably U-shaped for ease and repeatability of manufacture, resulting in manufacturing cost savings and consequently, a savings in the purchase price of anvil element adapter 22 for the consumer. However, alternative shapes of spring wire element 68 also achieve the desired retention effect.

Second spring wire element 88 is generally V-shaped, and includes first leg 70, second leg 74, and intermediate portion 72 disposed therebetween. Third spring wire element 90 is generally C-shaped, and includes first leg 70, second leg 74, and intermediate portion 72 disposed therebetween. Either of second and third spring wire elements 88 and 90, respectively, may be installed in groove 62 (FIG. 2) of plug element 50 (FIG. 2) in place of spring wire element 68 (FIG. 2). Cycle retention pull tests performed on each of spring wire elements 68, 88, and 90 indicate that both second and third spring wire elements 88 and 90 have an equivalent or better retaining capability of socket 24 (FIG. 1) onto plug element 50 than does spring wire element 68.

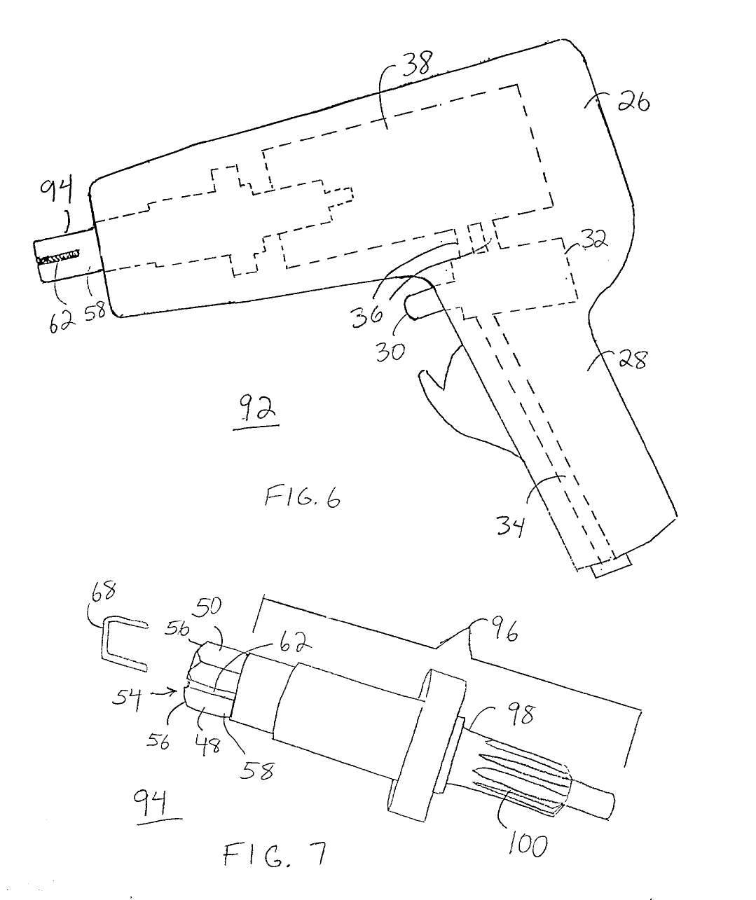

Referring to FIGS. 6-7, FIG. 6 shows a side view of an impact wrench 92 having a socket-drive anvil element 94 in accordance with an alternative embodiment of the present invention. FIG. 7 shows a perspective view of socket-drive anvil element 94. Anvil element adapter 22 (FIG. 1) is an aftermarket product for enhancing the retention capabilities of a pre-existing impact wrench. In an alternative embodiment, an original equipment manufacturer may include socket-drive anvil element 94 on impact wrench 92 thereby gaining the socket retention capabilities of adapter 22 without the need for inclusion of an aftermarket adapter.

Like impact wrench 20, impact wrench 92 includes housing 26 having handle 28 that supports finger-operated trigger 30, which is connected to valve 32 for controlling a flow of compressed air through passages 34 and 36 to rotary motor 38. However, wrench 92 does not include pre-existing anvil 40 (FIG. 1). Rather, socket-drive anvil element 94 directly interconnects with motor 38.

More specifically, socket-drive anvil element 94 includes a base 96 having a shaft portion 98 configured for interconnection with rotary motor 38. For example, gear teeth 100 along shaft portion 98 mate with a corresponding gear teeth (not shown) of motor 38 so that the rotary drive force from rotary motor 38 is transferred to socket-drive anvil element 94.

In all other respects, socket-drive anvil element 94 is configured similarly to anvil element adapter 22. Like adapter 22, four side faces 48 of plug element 50 extend from base 96 of socket-drive anvil element 94, and top face 54 is coupled to distal edge 56 of side faces 48. First side face 58 and second side face 60 (not visible), positioned on opposite sides of plug element 50, as well as top face 54, include groove 62 formed therein. Spring wire element 68, or alternatively one of second spring wire element 88 (FIG. 4) and third spring wire element 90 (FIG. 5), is secured in groove 62 and provides resistance to removal of wrench socket 24 (FIG. 1), as discussed previously.

In summary, the present invention teaches of a socket-drive anvil element in the form as an aftermarket anvil element adapter and, alternatively, as a socket-drive anvil element furnished with an impact wrench by an original equipment manufacturer. A spring wire element secured in a machined groove on a plug portion of the socket-drive anvil element applies an outward force on a socket wrench to effectively retain the socket wrench. The spring wire element is formed from piano spring wire and heat-treated to gain resiliency resulting in a socket-drive anvil element that is highly resistant to wear even in a high usage environment. The spring wire element configuration of the anvil element further allows for ready installation and removal of a wrench socket without the need for additional tools and or components, such as a retaining pin. In addition, the socket-drive anvil element is readily implemented on pre-existing impact wrenches and on new impact wrenches.

Although the preferred embodiments of the invention have been illustrated and described in detail, it will be readily apparent to those skilled in the art that various modifications may be made therein without departing from the spirit of the invention or from the scope of the appended claims.

What is claimed is:

1. A socket-drive anvil element for an impact wrench, said impact wrench including a motor for providing a rotary drive force to a wrench socket, said anvil element comprising:
a base configured for alignment with a rotational axis of said motor;
a plug element configured for receipt of said wrench socket, said plug element including side faces and a top face, said side faces coupled to and extending from said base, said top face coupled to a distal edge of said side faces, and a first side face and a second side face of said side faces and said top face having a continuous groove formed therein; and
a spring wire element secured in said groove and configured to provide resistance to removal of said wrench socket.

2. An anvil element as claimed in claim 1 wherein said base includes a shaft portion configured for interconnection with said motor.

3. An anvil element as claimed in claim 1 wherein said impact wrench includes a pre-existing anvil, and said base includes a socket portion configured for interconnection said pre-existing anvil.

4. An anvil element as claimed in claim 3 wherein:
said anvil element further comprises a set screw; and
said socket portion of said base includes a hole extending through a side wall of said socket portion, said set screw being threaded through said hole and configured to abut said pre-existing anvil to retain said anvil element on said preexisting anvil.

5. An anvil element as claimed in claim 1 wherein said first and second sides are on opposite sides of said plug element.

6. An anvil element as claimed in claim 1 wherein said first and second sides exhibit a length, said top face exhibits a width, and said groove extends substantially along said length of said first and second sides and said width of said top face.

7. An anvil element as claimed in claim 1 wherein said spring wire element is a continuous unit shaped to include a first leg, an intermediate portion, and a second leg, said first leg being positioned in said groove on said first side face, said intermediate portion being positioned in said groove on said top face, and said second leg being positioned in said groove on said second side face.

8. An anvil element as claimed in claim 7 wherein said spring wire element is formed from piano spring wire bent to form said continuous unit and heat-treated to gain resiliency.

9. An anvil element as claimed in claim 7 wherein said intermediate portion of said spring wire element is secured in said groove in said top face of said plug element.

10. An anvil element as claimed in claim 7 wherein said first and second legs extend from said groove and are configured to provide friction between said plug element and said wrench socket to retain said socket on said plug element.

11. An anvil element as claimed in claim 10 wherein said first and second legs retract into said groove in response to an external force imposed on said wrench socket to release said wrench socket from said plug element.

12. An anvil element as claimed in claim 1 wherein said spring wire element is U-shaped having a first leg, a second leg, and an intermediate portion disposed therebetween.

13. An anvil element as claimed in claim 1 wherein said spring wire element is V-shaped having a first leg, a second leg, and an intermediate portion disposed therebetween.

14. An anvil element as claimed in claim 1 wherein said spring wire element is C-shaped having a first leg, a second leg, and an intermediate portion disposed therebetween.

15. A socket-drive anvil element for an impact wrench, said impact wrench including a motor for providing a rotary drive force to a wrench socket, said anvil element comprising:
a base having a shaft portion configured for interconnection with said motor and axially aligned with a rotational axis of said motor;
a plug element configured for receipt of said wrench socket, said plug element including side faces and a top face, said side faces coupled to and extending from said base, said top face coupled to a distal edge of said side faces, and a first side face and a second side face of said side faces and said top face having a continuous groove formed therein; and
a spring wire element secured in said groove and configured to provide resistance to removal of said wrench socket, said spring wire element being a continuous unit shaped to include a first leg, an intermediate portion, and a second leg, said first leg positioned in said groove on said first side face, said intermediate portion positioned in said groove on said top face, and said second leg positioned in said groove on said second side face.

16. An anvil element as claimed in claim 15 wherein:
said intermediate portion of said spring wire element is secured in said groove in said top face of said plug element; and
said first and second legs extend from said groove on said first and second side faces and are configured to provide friction between said plug element and said wrench socket to retain said socket on said plug element.

17. An anvil element as claimed in claim 16 wherein said first and second legs retract into said groove in response to an external force imposed on said wrench socket to release said wrench socket from said plug element.

18. A socket-drive anvil element adapter for an impact wrench, said impact wrench including a motor for providing a rotary drive force to a wrench socket, and said impact wrench including a pre-existing anvil, said anvil element adapter comprising:
a base including a socket portion configured for interconnection said pre-existing anvil and axially aligned with a rotational axis of said motor;
a plug element configured for receipt of said wrench socket, said plug element including side faces and a top face, said side faces coupled to and extending from said base, said top face coupled to a distal edge of said side faces, and a first side face and a second side face of said side faces and said top face having a continuous groove formed therein; and
a spring wire element secured in said groove and configured to provide resistance to removal of said wrench socket, said spring wire element being a continuous unit shaped to include a first leg, an intermediate portion, and a second leg, said first leg positioned in said groove on said first side face, said intermediate portion positioned in said groove on said top face, and said second leg positioned in said groove on said second side face.

19. An anvil element adapter as claimed in claim 18 wherein:
said anvil element adapter further comprises a set screw; and
said socket portion of said base includes a hole extending through a side wall of said socket portion, said set screw being threaded through said hole and configured to abut said pre-existing anvil to retain said anvil element adapter on said pre-existing anvil.

20. An anvil element adapter as claimed in claim 18 wherein:
said intermediate portion of said spring wire element is secured in said groove in said top face of said plug element;
said first and second legs extend from said groove on said first and second side faces and are configured to provide friction between said plug element and said wrench socket to retain said socket on said plug element; and
said first and second legs retract into said groove in response to an external force imposed on said wrench socket to release said wrench socket from said plug element.
